(19) United States
(12) Patent Application Publication
(10) Pub. No.: US 2004/0184422 A1
(43) Pub. Date: Sep. 23, 2004

(54) Method and apparatus for performing a handoff in an inter-extended service set (I-ESS)

(75) Inventor: Kamel M. Shaheen, King of Prussia, PA (US)

Correspondence Address: VOLPE AND KOENIG, P.C., DEPT. ICC, UNITED PLAZA, SUITE 1600, 30 SOUTH 17TH STREET, PHILADELPHIA, PA, 19103, US

(73) Assignee: InterDigital Technology Corporation, Wilmington, DE (US)

(21) Appl. No.: 10/730,603

(22) Filed: Dec. 8, 2003

Related U.S. Application Data
(60) Provisional application No. 60/455,688, filed on Mar. 17, 2003.

(51) Int. Cl. H04Q 7/00

(52) U.S. Cl. 370/331; 370/338

(57) ABSTRACT

Method and apparatus for handoff between two stations of a wireless local area network/wireless wide area network (WLAN/WWAN) wherein a terminal, communicating with a first station, scans for a second station when its connection with said first station is lost, or for any other reasons, and establishes communication with a second station. The establishment of communication with the second station includes determining that the second station is different from the first station; associating with the second station; forwarding the identity of the first station to the second station; and using the identity of the first station to continue the original session through the second station. The handoff is equally successful when the stations involved in the handoff are both in the same network or wherein the stations are in different networks.

### CROSS REFERENCE TO RELATED APPLICATION(S)

This application claims priority from U.S. provisional application No. 60/455,688 filed Mar. 17, 2003, which is incorporated by reference as if fully set forth.

### FIELD OF INVENTION

The present application relates to Inter-Extended Service Sets (I-ESSs), and more particularly, to a method and apparatus for performing a handoff between ESSs.

### BACKGROUND

Scenarios exist wherein a wireless terminal (STA), in moving about a wireless local area network (WLAN) or a wireless wide area network (WWAN), comprised of a plurality of extended service sets (ESSs) may, due to its movement, lose contact with an access point (AP) in one ESS and thus desire to establish communication with another ESS. The ESSs may either be in the same network, i.e., either a WLAN network or a WWAN network, or may be in different networks, i.e., one in a WLAN network and the other in a WWAN network. It is thus desirable to provide a simple and yet effective method and apparatus for performing such a handoff, with or without loss of the original connection.

### SUMMARY

The present invention is characterized by utilizing an access router (AR) of the ESS originally communicating with the STA to achieve an effective handoff.

### BRIEF DESCRIPTION OF THE FIGURES

The present invention will be understood from a consideration of the accompanying figures, wherein like elements are designated by like numerals and, wherein:

FIGS. 1A and 1B, taken together, represent a schematic diagram of a handoff in an inter-extended service set (I-ESS) employing a terminal-based procedure.

FIG. 2 shows a schematic diagram representing a handoff in an I-ESS employing a system-based handoff procedure.

FIGS. 3A and 3B, taken together, show another system-based handoff procedure within I-ESSs.

FIGS. 4A and 4B, taken together, comprise a schematic diagram representing a handoff in an I-ESS which is terminal-based and wherein the connection of the STA with ESS-1 is not lost.

### DETAILED DESCRIPTION OF THE PREFERRED EMBODIMENTS

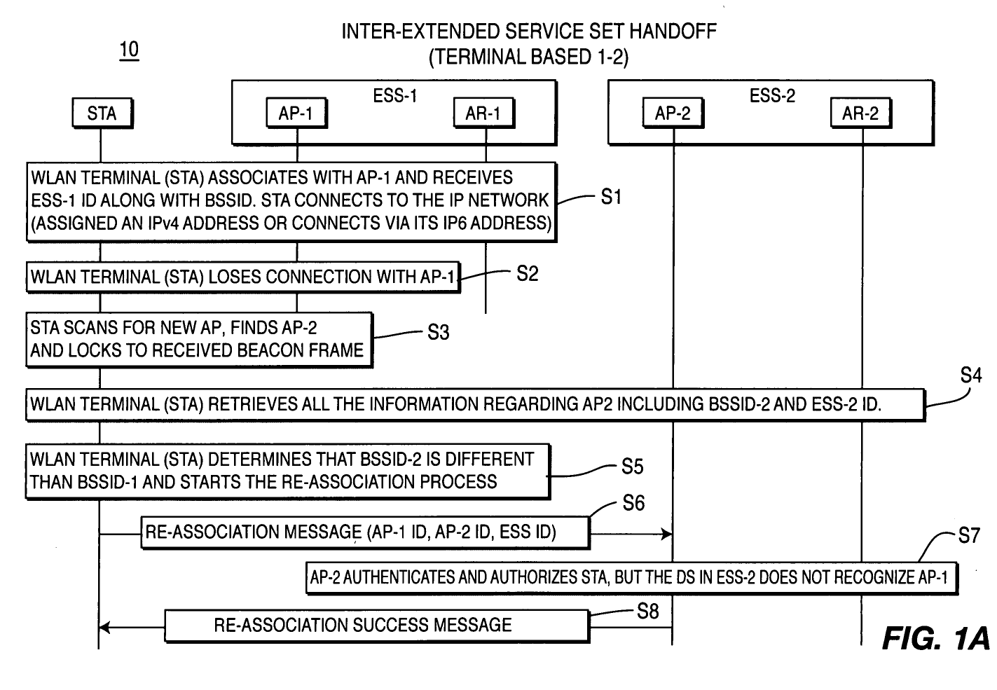

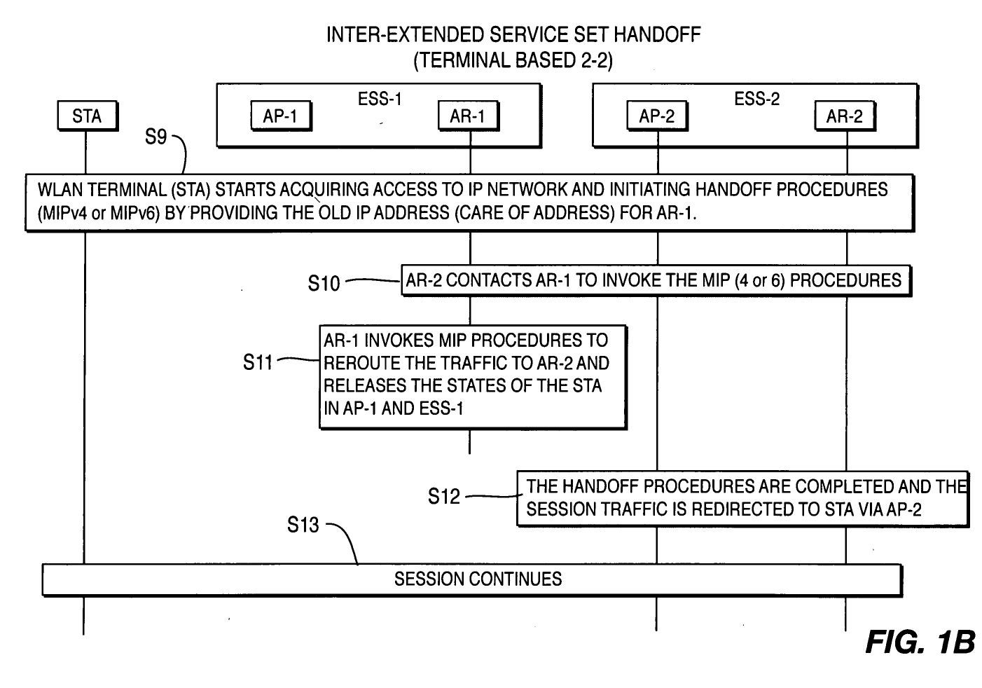

Making reference to FIGS. 1A and 1B there is shown therein a network of I-ESSs and a wireless STA capable of communication therewith. Although it should be understood that there may be any number of extended service sets (ESSs) and wireless stations (STAs) capable of communicating therewith, for purposes of simplicity, FIGS. 1A and 1B have been limited to a showing of two such extended service sets, ESS-1 and ESS-2, and a single wireless STA, it being understood that the method and apparatus disclosed herein may be employed with equal success in a network having a greater number of ESSs and wireless STAs.

Initially the STA, at step S1, associates with the access point (AP-1) of a first extended service set ESS-1, further having an access router AR-1.

At step S1, the STA receives the identification of ESS-1 (ESS-1 ID) along with the basic service set identifier (BSS ID). The STA is then connected to the internet protocol (IP) network and is assigned either an IP address (IPv4) address or alternatively is connected by way of its IP version 6 (IPv6) address.

At step S2, it is assumed that the STA loses its connection with AP-1 due to change of location of STA, noise, natural or manmade barriers, or for any other reason, whereby the STA, at step S3, scans for a new AP, finds AP-2 which is part of the extended service set ESS-2, and locks on to a received beacon frame from ESS-2. At step S4, the STA retrieves information regarding AP-2 including the basic service set identifier (BSSID-2) and the ID for ESS-2 (ESS-2 ID).

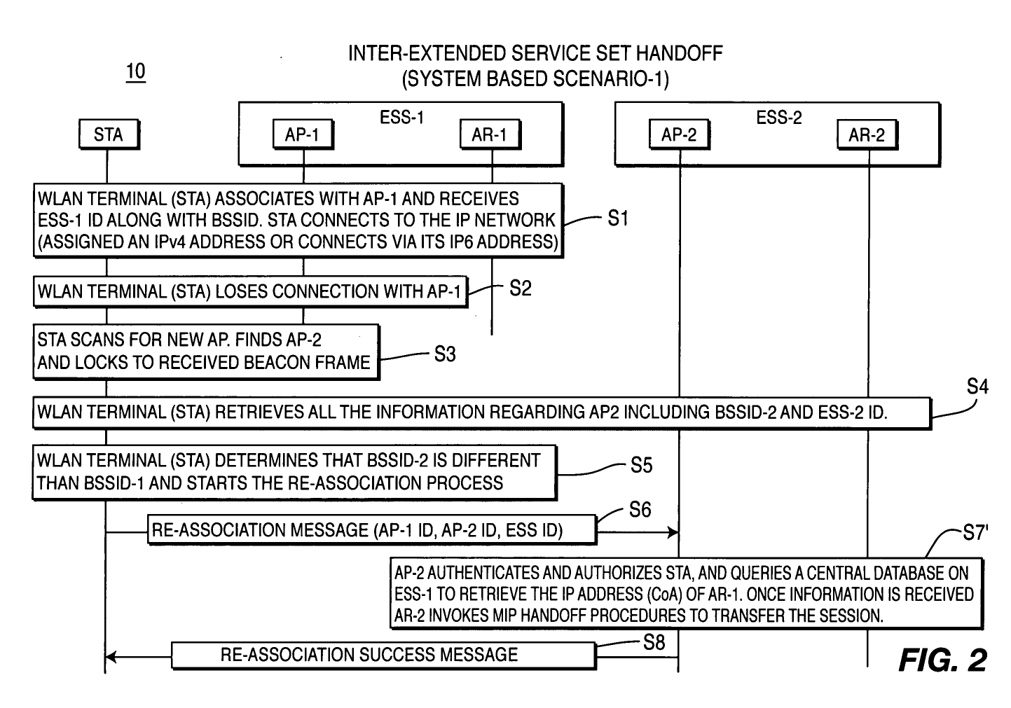

At step S5, the STA determines that BSSID-2 is not the same as BSSID-1 and thereby starts a re-association process whereupon, at step S6, the STA sends a re-association message which includes the AP-1 ID, the AP-2 ID and the ESSID. AP-2 of ESS-2, at step S7, authenticates and authorizes the STA, but the distribution system in ESS-2 fails to recognize AP-1. At step S8, AP-2 sends a re-association success message to the STA. At step S9, the STA acquires access to the IP network and initiates a handoff procedure deploying either mobile IPv4 (MIPv4) or mobile IPv6 (MIPv6) by providing the old IP address, also known as the care of address (CoA), which is typically used by a mobile user when roaming into a foreign IP network. At step S10, access router-2 (AR-2) contacts access router-1 (AR-1), invoking the MIP (4 or 6) procedures and, at S11, AR-1 reroutes the traffic to AR-2 and releases the states of the STA in AP-1 and ESS-1. At step S12, the handoff procedure is completed and the session traffic is redirected to the STA via AP-2 whereupon, at step S13, the original session is continued. Whereas the embodiment of FIGS. 1A-1B shows the manner in which a handoff is made from an ESS-1 to an ESS-2 in a WLAN network, it should be understood that handoffs of WWAN to WWAN, WLAN to WWAN and WWAN to WLAN may be performed with equal success employing the algorithm of the present invention. The above combinations also apply to the embodiments of FIGS. 2 to 4B.

FIG. 2 shows a system-based handoff wherein only those steps which distinguish from the steps in FIG. 1A/1B are designated with a “prime”. Making reference to FIG. 2, steps S1 through steps S6 are substantially identical to steps S1 through steps S6 as shown in FIG. 1A. At step S7′, AP-2, in addition to authenticating and authorizing the STA, queries an essential data base in ESS-1 to retrieve the IP address (i.e., the CoA) of AR-1 and, upon receipt of this information, AR-2 invokes an MIP handoff procedure to transfer the session thereafter sending a re-association success message at S8. It should be understood steps S9 through S13 shown in FIG. 1B or steps similar thereto should follow step S8 of FIG. 2. These steps have been omitted in FIG. 2 for simplicity.

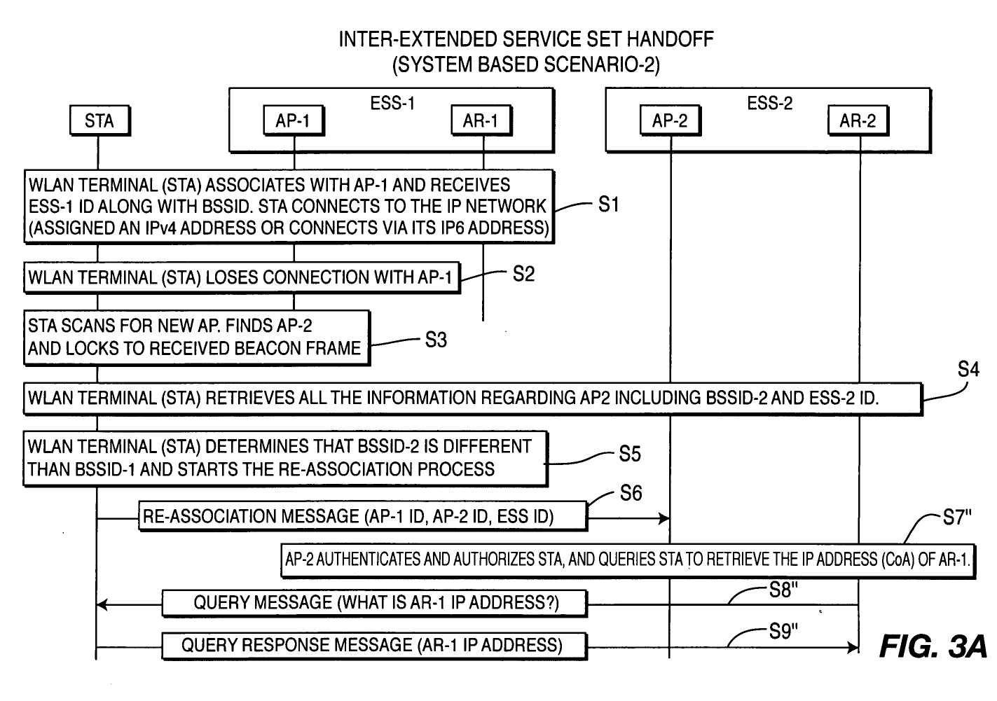

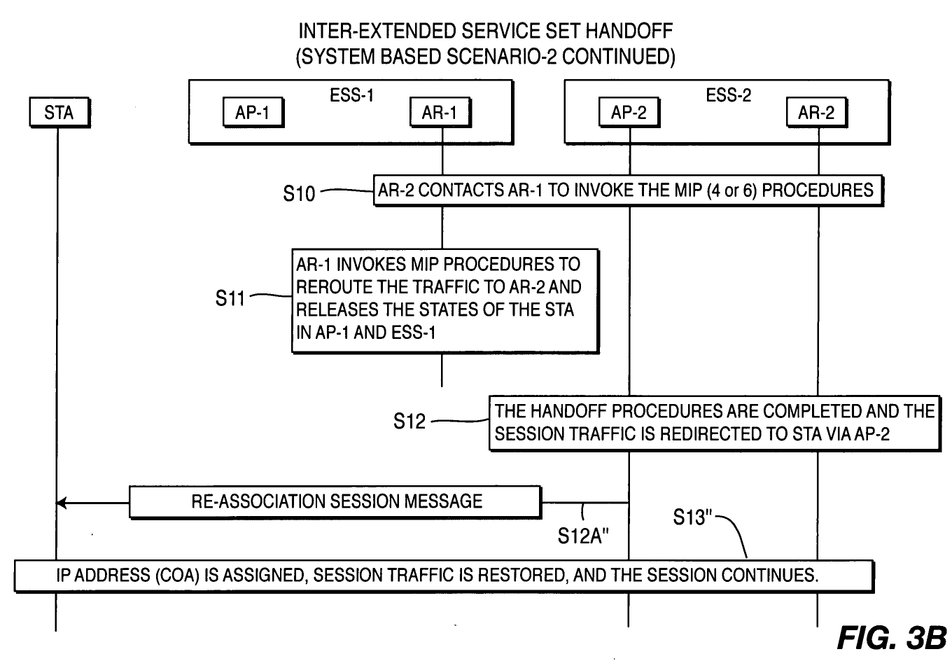

FIGS. 3A and 3B show another scenario wherein a modified system-based handoff is provided and the ESS-2 queries the STA.

Making reference to FIGS. 3A and 3B, steps similar to those shown in FIGS. 1A and 1B are shown “unprimed”; steps similar to the “primed” steps in FIG. 2 are shown “primed” and steps different from those shown in FIGS. 1A, 1B and 2 are designated with a “double prime”.

Making reference to FIGS. 3A and 3B steps S1 through S6 are substantially identical to steps S1 through S6 of FIG. 1, for example. At step S7″, AP-2 of ESS-2 authenticates and authorizes the STA and queries the STA to retrieve the IP address (CoA) of AR-1 and, at step S8″, queries the STA as to the IP address of AR-1. The STA, at step S9″, responds by providing the IP address of AR-1. AR-2, at step S10 contacts AR-1 and invokes the MIP (4 or 6) procedures. Steps S11 and S12 follow step S10 whereupon AP-2 sends the STA a re-association success message at step S12′, followed by restoration of the session traffic, at S13″.

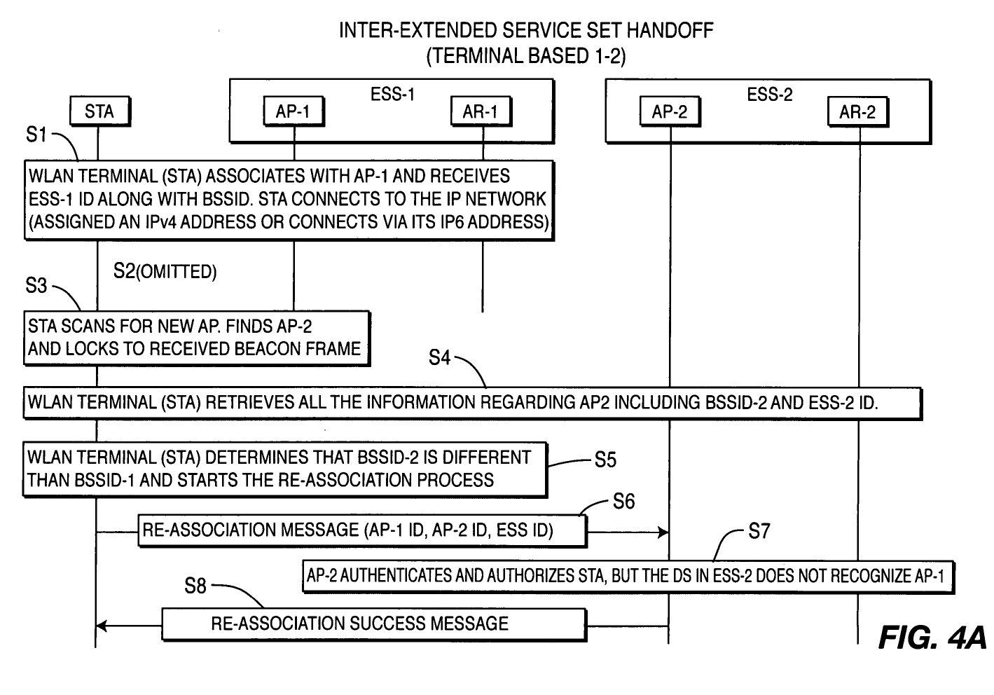

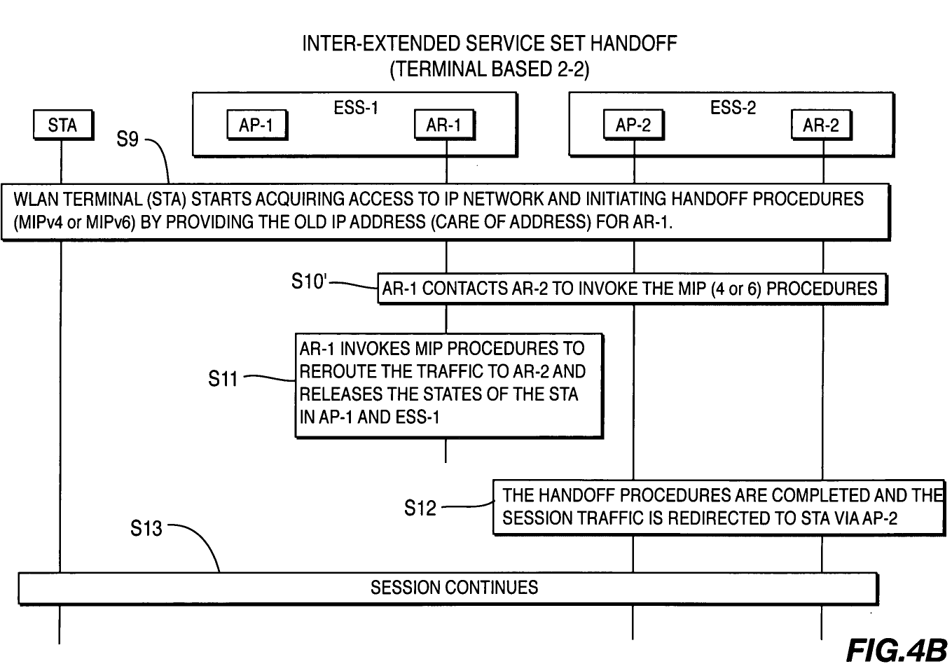

FIGS. 4A and 4B show a terminal-based handoff scenario in which the original connection is not lost.

Steps S1 through S9 are substantially the same as steps S1-S9 of FIG. 1A/1B except that step S2 is omitted. However, although the session established through ESS-1 has not been interrupted, it is assumed that the STA desires (for whatever reason) to initiate a handoff. At step S9, the STA contacts AP-1 to initiate a handoff.

After step S9, AR-1, at step S10, contacts AR-2 to invoke the MIP (4 or 6) procedures. The remaining steps S11-S13 are the same as in FIG. 1A/1B. However, since the STA is still connected to ESS-1, AR-1, at step S10′, initiates the handoff.

Station-initiated handoffs in scenarios when the session is not lost are performed in a manner similar to that in FIG. 3A/3B. More particularly, in FIG. 3A/3B, step S2 is omitted when the connection is not lost and step S10 is modified wherein AR-1 contacts AR-2 and invokes the MIP (4 or 6) procedures. The remaining steps S11-S13 remain unchanged.

What is claimed is:

1. A method for handoff of a wireless terminal between first and second stations in one of a wireless local area network (WLAN) and a wireless wide area network (WWAN), wherein the stations may both be part of a WLAN or a WWAN or one station is part of one of a WLAN or a WWAN and the other station is part of a remaining one of the WLAN and WWAN comprising:
said terminal:
responsive to loss of a connection with said first station, scanning for said second station;
retrieving information from said second station;
determining that the second station is different from said first station;
transmitting an association message to said second station, and, upon receipt of an association success message from said second station, initiates a handoff, providing to said second station information regarding said first station;
said second station contacting said first station responsive to the information received from said terminal;
said first station rerouting traffic to said second station and releasing said first station; and
said second station responsive to the handoff procedure initiated by said first station reestablishing the session between said terminal and said second station.

2. A method for handoff of a wireless terminal between first and second stations in one of a wireless local area network (WLAN) and a wireless wide area network (WWAN), wherein the stations may both be part of a WLAN or a WWAN or one station is part of one of a WLAN or a WWAN and the other station is part of a remaining one of the WLAN and WWAN, comprising:
said terminal:
responsive to loss of a connection with said first station, scanning for said second station;
retrieving information regarding said second station;
determining that the second station is different from said first station;
transmitting an association message to said second station including information about the first station;
said second station contacting said first station responsive to the information received from said terminal to obtain an IP address of said lost connection;
said terminal providing the IP address of said lost connection responsive to the request therefor;
said second station contacting said first station to initiate a handoff from the first station to the second station;
said first station rerouting traffic to said second station and releasing said first station; and
said second station, responsive to the handoff procedure initiated by said first station reestablishing the session between said terminal and said second station.

3. A method for handoff of a wireless terminal between first and second stations in one of a wireless local area network (WLAN) and a wireless wide area network (WWAN), wherein the stations may both be part of a WLAN or a WWAN or one station is part of one of a WLAN or a WWAN and the other station is part of a remaining one of the WLAN and WWAN, comprising:
said terminal:
responsive to loss of a connection with said first station, scanning for said second station;
retrieving information regarding said second station;
determining that the second station is different from said first station;
transmitting an association message to said second station, including information about the second station;
said second station contacting said terminal responsive to the information received from said first station to obtain an IP address of the lost connection;
said second station contacting the first station to initiate the handoff;
said first station rerouting traffic to said second station and releasing said first station; and
said second station, responsive to the handoff procedure initiated by said first station reestablishing the session between said terminal and said second station.

4. A method for handoff of a wireless terminal between first and second stations in one of a wireless local area network (WLAN) and a wireless wide area network (WWAN), wherein the stations may both be part of a WLAN or a WWAN or one station is part of one of a WLAN or a WWAN and the other station is part of a remaining one of the WLAN and WWAN, comprising:
said terminal:
while connected to said first station, scanning for a second station;
retrieving information from said second station;
determining that the second station is different from said first station;
transmitting an association message to said second station, and, upon receipt of an association success message from said second station, initiates handoff, providing to said first station information regarding said second station;
said first station contacting said second station responsive to the information received from said terminal;
said first station rerouting traffic to said second station and releasing said first station; and
said second station responsive to the handoff procedure initiated by said first station reestablishing the session between said terminal and said second station.

5. A method for handoff of a wireless terminal between first and second stations in one of a wireless local area network (WLAN) and a wireless wide area network (WWAN), wherein the stations may both be part of a WLAN or a WWAN or one station is part of one of a WLAN or a WWAN and the other station is part of a remaining one of the WLAN and WWAN, comprising:
said terminal:
while connected to said first station scanning for said second station;
retrieving information from said second station;
determining that the second station is different from said first station;
transmitting an association message to said second station including information about the first station;
said second station contacting said terminal to obtain an IP address of said connection;
said terminal providing the second station with IP address of said connection responsive to the request therefor;
said second station contacting said first station to initiate a handoff from the first station to the second station;
said first station rerouting traffic to said second station and releasing said first station; and
said second station responsive to the handoff procedure initiated by said first station reestablishing the session between said terminal and said second station.

6. A method for handoff of a wireless terminal between first and second stations in one of a wireless local area network (WLAN) and a wireless wide area network (WWAN), wherein the stations may both be part of a WLAN or a WWAN or one station is part of one of a WLAN or a WWAN and the other station is part of a remaining one of the WLAN and WWAN, comprising:
said terminal:
while connected to said first station, scanning for said second station;
retrieving information from said second station;
determining that the second station is different from said first station;
transmitting an association message to said second station, including information about the first station;
said second station contacting said terminal to obtain an IP address of said connection;
said second station contacting the first station to initiate the handoff;
said first station rerouting traffic to said second station and releasing said first station; and
said second station having means responsive to the handoff procedure initiated by said first station for reestablishing the session between said terminal and said second station.

7. Apparatus for handoff of a wireless terminal between first and second stations in one of a wireless local area network (WLAN) and a wireless wide area network (WWAN), wherein the stations may both be part of a WLAN or a WWAN or one station is part of one of a WLAN or a WWAN and the other station is part of a remaining one of two WLAN and WWAN, comprising:
said terminal comprising:
means responsive to loss of a connection with a first one of said stations, scanning for said second station;
means for retrieving information from said second station;
means for determining that the second station is different from said first station;
means for transmitting an association message to said second station, and, upon receipt of an association success message from said second station, initiating a handoff and providing to said second station information regarding said first station;
said second station comprising:
means for requesting said first station to initiate a handoff responsive to the information received from said terminal;
said first station comprising:
means for rerouting traffic to said second station and releasing said first station; and
said second station having means responsive to the handoff procedure initiated by said first station for reestablishing the session between said terminal and said second station.

8. The apparatus of claim 7 wherein said first and second stations are each comprised of an extended service set (ESS) having an access point and an access router.

9. The apparatus of claim 8 wherein the ESS of said first station includes means for providing said terminal with an ESS identification (ESS ID) and a basic service set identifier (BSS ID).

10. The apparatus of claim 9 wherein the means for retrieving information from said second station retrieves an ESS ID and BSS ID of said second station for use by said means for determining.

11. The apparatus of claim 9 wherein said terminal further comprises means for connecting to an internet protocol (IP) network wherein said terminal is assigned an IP address.

12. The apparatus of claim 9 wherein said terminal further comprises means for connecting to an internet protocol (IP) network wherein said terminal is connected through an IP address of said terminal.

13. The apparatus of claim 7 wherein said scanning means includes means to lock on to a beacon from said second station.

14. Apparatus for handoff of a wireless terminal between first and second stations in one of a wireless local area network (WLAN) and a wireless wide area network (WWAN), wherein the stations may both be part of a WLAN or a WWAN or one station is part of one of a WLAN or a WWAN and the other station is part of a remaining one of the WLAN and WWAN, comprising:
said terminal comprising:
means responsive to loss of a session obtained by connection with said first station, to scan for said second station;
means for retrieving information from said second station;
means for determining that the second station is different from said first station;
means for sending an association message to said second station including information about the first station;
said second station comprising:
means for contacting said first station responsive to the information received from said terminal to obtain an IP address of said lost connection;
said terminal having means for providing the IP address of said lost connection responsive to the request therefor;
said second station having means for requesting said first station to initiate a handoff from the first station to the second station;
said first station having means for rerouting traffic to said second station and releasing said first station; and
said second station having means responsive to the handoff procedure initiated by said first station for reestablishing the session between said terminal and said second station.

15. Apparatus for handoff of a wireless terminal between first and second stations in one of a wireless local area network (WLAN) and a wireless wide area network (WWAN), wherein the stations may both be part of a WLAN or a WWAN or one station is part of one of a WLAN or a WWAN and the other station is part of a remaining one of the WLAN and WWAN, comprising:
said terminal comprising:
means responsive to loss of a connection with a first one of said stations, to scan for a second station;
means for retrieving information regarding said second station;
means for determining that the second station is different from said first station;
means for sending an association message to said second station, including information about the second station;
said second station having:
means for contacting said terminal responsive to the information received from said first station to obtain an IP address of the lost connection; and
means for requesting the first station to initiate the handoff;
said first station having means for rerouting traffic to said second station and releasing said first station; and
said second station having means responsive to the handoff procedure initiated by said first station for reestablishing the session between said terminal and said second station.
